(19) United States
(12) Patent Application Publication
(10) Pub. No.: US 2003/0113112 A1
(43) Pub. Date: Jun. 19, 2003

(54) Mask for preventing undesired light from entering lens of a camera

(76) Inventors: Chih-Po Yang, Taipei (TW); Chin-Yu Lin, Taipei (TW)

Correspondence Address: SNELL & WILMER, ONE ARIZONA CENTER, 400 EAST VAN BUREN, PHOENIX, AZ, 850040001

(21) Appl. No.: 10/320,251

(22) Filed: Dec. 16, 2002

(30) Foreign Application Priority Data
Dec. 17, 2001 (TW) 090131196

(51) Int. Cl. G03B 11/00

(52) U.S. Cl. 396/544

(57) ABSTRACT

A mask for preventing undesired light from entering the lens of the camera. The mask includes a transparent plate and a membrane for blocking undesired light. The membrane is disposed on the periphery of the transparent plate and the aperture is formed on the center of the membrane. The mask is attached onto the camera housing to make the aperture properly located in front of the lens or the viewfinder of the camera.

### CROSS REFERENCE TO RELATED APPLICATIONS

This Application claims priority to Taiwan Patent Application No. 090131196 filed Dec. 17, 2001.

### FIELD OF INVENTION

The present invention relates to a camera and a method for preventing undesired light from entering the lens of the camera. More particularly the present invention relates to using a mask for blocking the undesired light, which if not blocked, may deteriorate the image quality.

### BACKGROUND OF THE INVENTION

To the human being's eyes or the camera, light creates the image. As the photography developed over the centuries, the modern optical technique uses a set of lenses to focus an image on a plane for forming a clear image. The material of the lens can be glass or other transparent material.

As mentioned above, the lens functions to focus light, and the quality of an image depends on the ways of implementing lens. The material, polish quality and coating technology of lens affect the accuracy of the image. For instance, the fluorite lens and better coating technique can reduce the chromatic dispersion of the image. Non-spherical lens can reduce the distortion of the image. Distinct combinations of multiple lenses result in distinct angle of views, perspectives or variable focal length.

To reduce undesired light which enters the lens and influences the image quality, some prior art techniques use a mask within the lens to block the undesired light for sustaining the quality of image. Similarly, the undesired light also enters the viewfinder, which either includes a set of lenses or is an independent system connecting to the lens. When the operator finds a view through the viewfinder with a mask, the adverse effect of undesired light is reduced. However, provision of a mask not only affects the shape of lens, but increases the cost of design and production.

### SUMMARY OF THE INVENTION

One aspect of the invention is to provide a camera mask, a camera and a method for blocking undesired light without changing the shape of lens.

The camera mask includes a transparent plate and a membrane for blocking undesired light. The membrane is disposed on the transparent plate, and there is an aperture formed thereon.

Another aspect of the present invention provides a camera including a lens, a viewfinder and a mask for blocking undesired light. The mask is located in front of the lens or the viewfinder and is attached onto the camera housing.

Still another aspect of the present invention provides a method for blocking undesired light. The method includes providing a mask and disposing the mask in front of the lens or viewfinder attached onto the camera housing. The mask includes a membrane having an aperture, which is disposed on a transparent plate for blocking undesired lights.

### BRIEF DESCRIPTION OF THE DRAWINGS

FIG. 1 illustrates a mask having a membrane and an aperture;

FIG. 2 illustrates the cross-section of the mask having a membrane and an aperture;

FIG. 3 illustrates a mask, for blocking undesired light, located in front of a lens and attached onto the camera housing;

FIG. 4 illustrates a mask, for blocking undesired light, located in front of a viewfinder and attached onto the camera housing;

FIG. 5 illustrates a camera of the present invention having a lens module and a viewfinder module, illustrating the mask for blocking undesired light located in front of the lens and viewfinder and attached onto the camera housing;

FIG. 6 illustrates the flowchart of the method of the present invention;

FIG. 7 illustrates another flowchart of the method of the present invention.

### DETAILED DESCRIPTION OF THE INVENTION

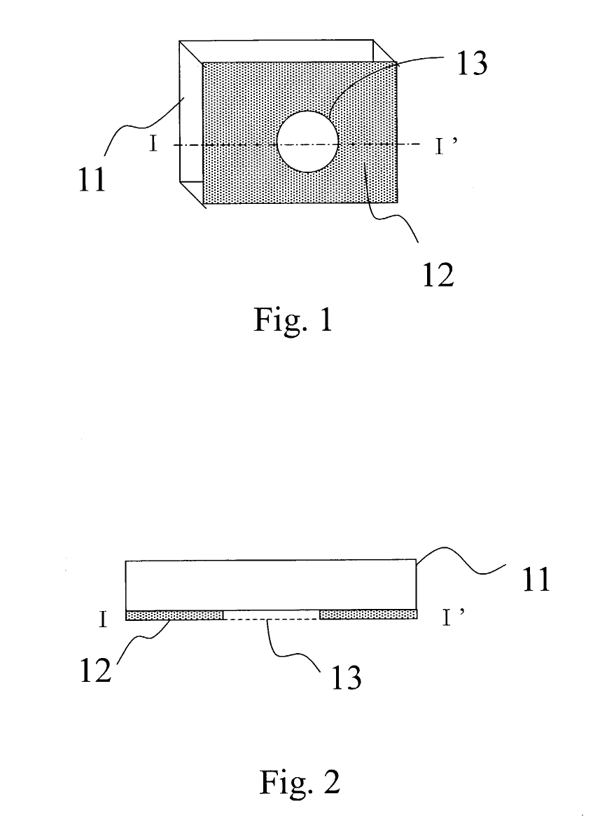

The present invention provides a mask attached on the camera housing for preventing undesired light from entering the lens of the camera. As shown in FIG. 1, the present invention provides a mask comprising the transparent plate 11 and the opaque membrane 12 coated or printed along the periphery of the transparent plate 11. The opaque membrane 12 blocks the undesired light that may damage the quality of image captured by the camera. There is an aperture 13 formed on the center of the opaque membrane 12 to allow the image light to pass through. The size of the aperture 13 can be adjusted according to the demand of the designer. FIG. 2 discloses the cross-section along the line I-I′ in FIG. 1 of the present invention.

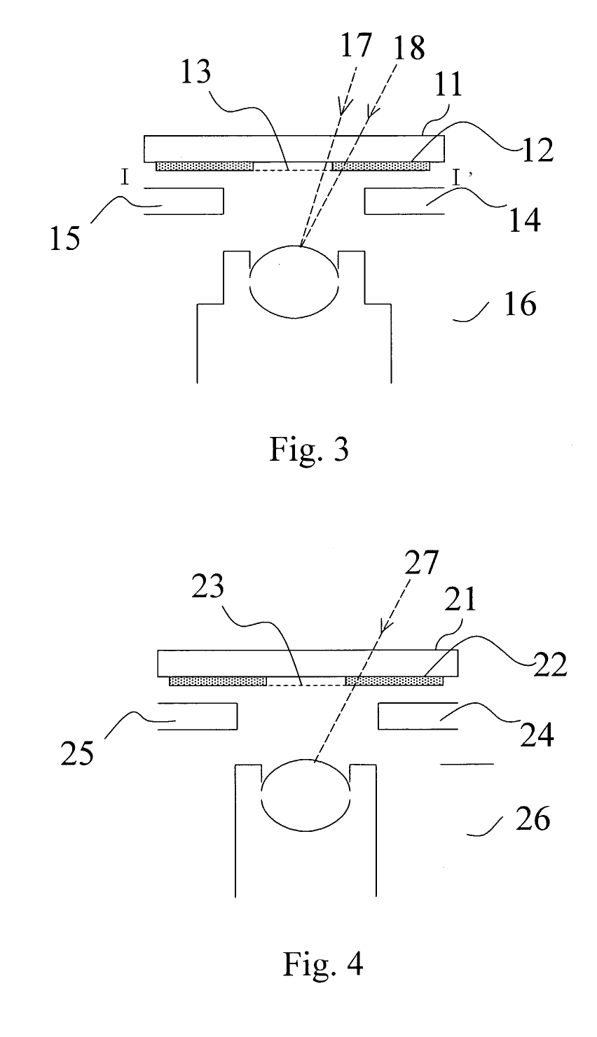

As shown in FIG. 3, the membrane 12 disposed on the transparent plate 11 blocks the undesired light 18 that damages the quality of image captured by the camera, but the aperture 13 allows the image light 17 to pass though. Further, none of the transparent plate 11, the membrane 12, and the aperture 13 is located within the lens module 16. The mask is attached onto the camera housings 14, 15 to make the aperture 13 properly located in front of the lens module 16 to let the light 17 pass through, and the membrane 12 properly disposed around the lens to block the undesired light 18.

Without changing original mechanical design of the viewfinder module, the same inventive mask can be applied to the camera viewfinder to improve the viewfinder coverage or angle of view. As shown in FIG. 4, the present invention discloses the mask comprising the transparent plate 21, the opaque membrane 22 disposed on the periphery of the transparent plate 21, and the aperture 23 formed on the center of the membrane 22. The mask is attached onto the camera housing 24, 25 to make the aperture 23 properly located in front of the viewfinder module 26, and the membrane 22 disposed around the viewfinder module 26 to block the undesired light 27.

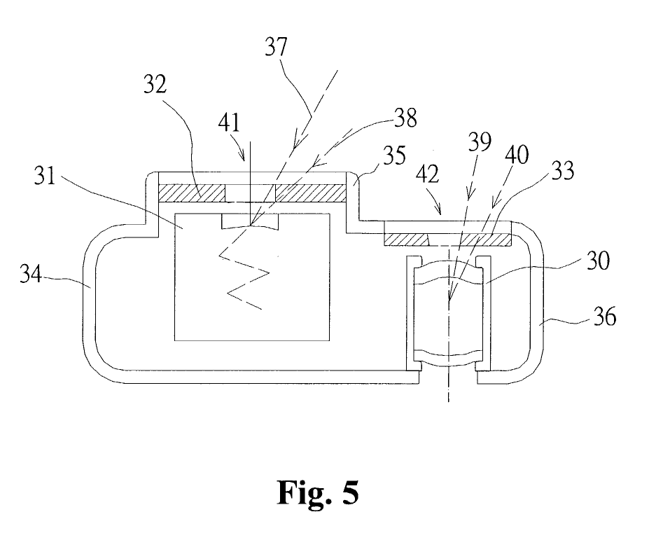

FIG. 5 discloses a camera of the present invention. The camera mentioned here is not limited to the traditional camera using the film to capture the image. The camera here also means the digital still camera (DSC) using image sensors to capture the image, and further includes specialized camera such as the camcorder capable to record the video image. The camera has a lens module 31 and a viewfinder module 30. The masks for blocking undesired lights are located in front of the lens module 31 and viewfinder module 30 respectively, and both masks are attached onto the camera housings 34, 35, 36. When an undesired light 38 is present, the membrane 32 disposed on the periphery of the transparent plate blocks the undesired light 38 and only allows the light 37 corresponding to the image to pass through the first aperture 41. Similarly, when an undesired light 40 intrudes into the viewfinder module 30, the membrane 33 blocks the undesired light 40 and only allows the light 39 corresponding of image to pass through the second aperture 42.

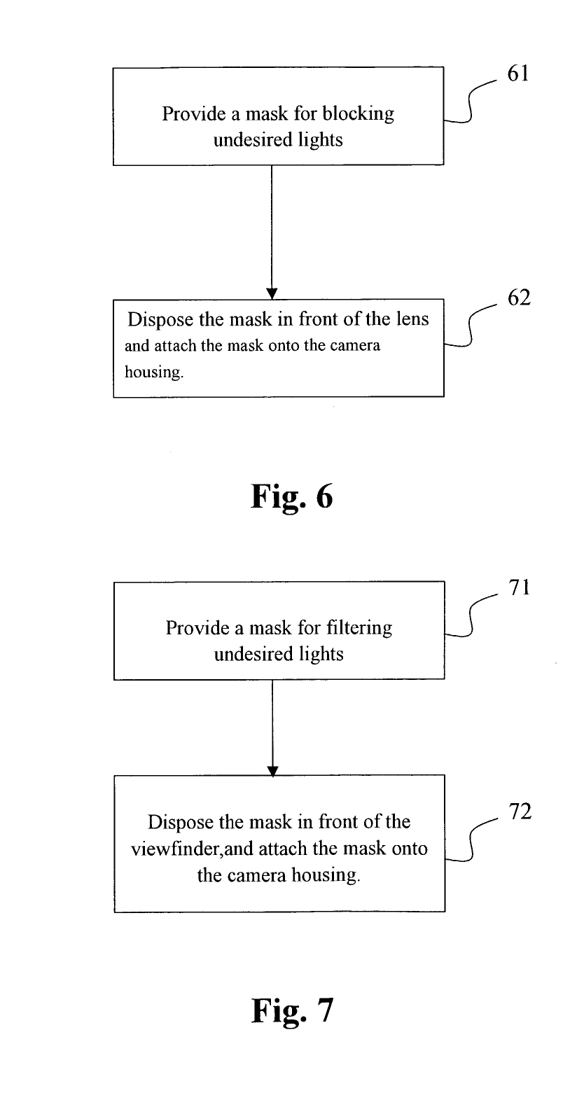

The present invention also provides a method for preventing undesired light from entering the lens of the camera. With reference to FIG. 6, the method includes: (a) providing a mask for blocking the undesired lights 61, and (b) disposing the mask in front of the lens, and attaching the mask onto the camera housing 62 for blocking undesired light. The mask has a membrane and an aperture formed thereon. Similarly, as shown in FIG. 7, a method for preventing undesired light from entering the lens of the camera includes: (a) providing a mask for blocking undesired light 71, and (b) disposing the mask in front of the viewfinder, and attaching the mask onto the camera housing 72. The method improves the viewfinder coverage or angle of view.

In optical system, using of mask will affect the parameters of pupil location, diaphragm size and aberration, etc. of the system. Therefore, the designer should take the relevant parameters into consideration when using the present invention. Depending on the actual demand and other considerations, the designer determines aperture size of the mask and the distance between mask and lens or viewfinder, etc.

While this invention has been described with reference to an illustrative embodiment, this embodiment is not intended to be construed in a limiting sense. Various modifications of the illustrative embodiment, as well as other embodiments of the invention, will be apparent to persons skilled in the art upon reference to this description. It is therefore contemplated that the appended claims will cover any such modifications or embodiments as falling within the true scope of the invention.

We claim:

1. A mask for preventing undesired light from entering a lens of a camera, said mask comprising:
a transparent plate; and
a membrane disposed on the periphery of said transparent plate for blocking said undesired lights, said membrane having an aperture formed thereon.

2. The mask of claim 1, wherein said transparent plate is located in front of a camera lens and is attached onto a camera housing.

3. The mask of claim 1, wherein said transparent plate is located in front of a camera viewfinder and is attached onto the camera housing.

4. The mask of claim 1, wherein said membrane is printed on said transparent plate.

5. The mask of claim 1, wherein said membrane is coated on said transparent plate.

6. A camera, comprising:
a lens;
a viewfinder;
a transparent plate; and
a membrane disposed on the periphery of said transparent plate for blocking undesired light, said membrane having an aperture formed thereon.

7. The camera of claim 6, wherein said transparent plate is located in front of said lens and is attached onto a camera housing.

8. The camera of claim 6, wherein said transparent plate is located in front of said viewfinder and is attached onto the camera housing.

9. The camera of claim 6, wherein said membrane is printed on said transparent plate.

10. The camera of claim 6, wherein said membrane is coated on the transparent plate.
